(19) United States
(12) Patent Application Publication
(10) Pub. No.: US 2016/0168388 A1
(43) Pub. Date: Jun. 16, 2016

(54) METALLIC PIGMENTS AND METHOD OF COATING A METALLIC SUBSTRATE

(71) Applicants: ECKART GMBH, Hartenstein (DE); SG VENTURES PTY LIMITED, Sydney (AU)

(72) Inventors: Christophe Jean Alexandre Barbe, Five Dock (AU); Kim Suzanne Finnie, Chatswood (AU); Oliver Dieter Bedford, Ober-Ramstadt (DE); Oliver Struck, Henfenfeld (DE)

(21) Appl. No.: 14/908,682

(22) PCT Filed: Jul. 29, 2014
(86) PCT No.: PCT/AU2014/050155

§ 371 Date: Jan. 29, 2016

(30) Foreign Application Priority Data
Jul. 29, 2013 (AU) 2013902797

(51) Int. Cl. C09C 3/00; C09C 3/12; C09C 3/06; C09C 1/64

(52) U.S. Cl. CPC C09C 3/006; C09C 1/648; C09C 3/12; C09C 3/063

(57) ABSTRACT

A metallic pigment is provided including a metallic substrate coated with a hybrid inorganic/organic layer, wherein the hybrid inorganic/organic layer includes a network of an inorganic component and at least one organofunctional silane component having organic functionalities which have not been polymerised. Also, a method of coating a metallic substrate is provided including: combining the metallic substrate with a surfactant and an organofunctional silane and an inorganic component precursor to form a hydrophobic phase; combining the hydrophobic phase with a hydrophilic liquid to form an emulsion including said hydrophobic phase containing the metallic substrate, the organofunctional silane and the inorganic component precursor dispersed in a continuous hydrophilic phase; adding a catalyst to the emulsion; and forming a hybrid organic/inorganic layer from the organofunctional silane and said inorganic component precursor on the metallic substrate to produce a coated metallic substrate.

### FIELD OF INVENTION

The present invention relates to a metallic pigments, such as so-called metallic effect pigments, and methods of coating metallic substrates. In particular, the invention relates to metallic pigments, such as those comprising lamellar metal pigment particles as the metallic substrate, where a hybrid material layer is coated onto the metallic substrate. The hybrid material layer advantageously reduces or eliminates exposure of the metallic substrate to the external environment.

### BACKGROUND ART

Processes involving the encapsulation of active molecules in ceramic particles for the purpose of subsequent controlled release into the surrounding environment are known. The actives may be releasable due to the porous nature of the ceramic matrix. There are, however, applications in which release of actives must be minimized, such as in the encapsulation of dyes for purposes which require stability in the colour of the particles. In other situations, it may be the composition of the matrix forming the particles which must not change, rather than the encapsulation of an active which must be preserved. In both situations, a coating which prevents the leaching of an encapsulated active, or protects the core material from contact with elements in the surrounding environment, is desirable.

K. Finnie, C. Barbé, and L. Kong (WO 2006/133519) disclose a method for producing organically modified silica particles with incorporated hydrophobic actives. A more recent study by Kong et at (‘Synthesis of silica nanoparticles using oil-in-water emulsion and the porosity analysis’, Linggen Kong, Akira Liedono, Suzanne V. Smith, Yukihiro Yamashita and Ilkay Chironi, J. Sol-gel Science Technol., 64 (2), 309-314, 2012) using positron annihilation lifetime spectroscopy, showed that freeze-dried particles made by this method, using 60% phenyltrimethoxysilane and 40% tetraethylorthosilicate as reagents, have approximately 0.6 nm pores. The rate of release of actives into the surrounding medium is dependent on several factors, such as the size of the active molecule, the affinity of the active for the matrix and the solubility of the active in the medium. Typically, the immersion of particles in solvent results in rapid leaching of hydrophobic molecules from the particles.

Lamellar aluminium pigments are a good example of a material which requires protection in aqueous environments, particularly in the typically alkaline environment of a water-based paint. Hydrolysis of the finely divided metal flakes results in production of hydrogen gas, with the associated risk of pressurization and potential explosion in accordance with the following equations:

Al+3H₂O→Al(OH)₃+1.5H₂

Al+OH—+3H₂O→[Al(OH₄)]⁻+1.5H₂

Gaseous stable aluminium pigments are commercially available under the trade name Hydrolux (Eckart GmbH). The passivation layer of these pigments is a mixed layer of chromium and aluminium oxide.

Ecologically friendly alternatives are sol-gel silica coated aluminium effect pigments. These pigments are commercially available under the trade names Hydrolan® (Eckart GmbH). Effect pigments which additionally include a first coating of a molybdenum oxide are described in EP 1 619 222 B1 and are commercially available under the trade name Emeral® (Toyo Aluminium Kabushiki Kaisha, Japan). Coating of the metal pigments can take quite a long time, which may be considered disadvantageous. Additionally, as the protection layers are inorganic oxides they are susceptible to mechanical shear stress which can lead to fracturing of the protection layers. As a result, the pigments may lose their gassing stability.

US 2008/0249209 A1 discloses metal effect pigments coated with a hybrid inorganic/organic coating. The hybrid layer involves organic oligomers or polymers which are covalently bound to the inorganic network, which is preferably a metal oxide. These metal pigments are more resistant to mechanical shear stress and still exhibit gassing stability. However, it is generally considered quite difficult to conduct a sol-gel process forming a metal oxide and, at the same time, an organic polymerisation in the same reactor. Effect pigments obtained have been very stable, but have been found to lack reproducibility to a certain degree. Also, the optical properties of these pigments, such as flop and brightness, have been found to be unsatisfactory.

It would be advantageous if a coating method could be devised that results in rapid condensation of a coating layer on particles which reduces or prevents ingress of the surrounding medium into the core material forming the particles. Moreover, it would be desirable for this coating to have a certain degree of ductility to resist mechanical shock and abrasion and thus provide an enhanced protection of the core substrate, while having at the same time good optical properties such as flop.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF INVENTION

In one aspect of the invention there is provided a metallic pigment comprising a metallic substrate coated with a hybrid inorganic/organic layer, wherein the hybrid inorganic/organic layer comprises a network of an inorganic component and at least one organofunctional silane component having organic functionalities which have not been polymerised.

As used herein the term “network” refers to a layer structure in which the inorganic component comprises the body of the layer throughout which the organofunctional silane is dispersed, generally relatively homogeneously. The term is not intended to include situations where a layer of inorganic material, such as a metal oxide, is coated onto the metallic substrate and functionality applied to an external surface of the layer of the inorganic material.

As used herein, the term “polymerised” includes within its scope any farm of polymerisation of the organic functionalities of the organofunctional silane including oligomerisation of the organic functionalities. As used herein, the term “oligomerisation” includes within its scope oligomerisation of oligomers from two to twenty monomer units.

As used herein, the term “metallic substrate” is not particularly limited and is intended to include metallic substrates of any form. For example, but without limitation, the term is intended to include within its scope regular or irregular (i.e. non-spherical) metallic particles, including lamellar or platelet-like metallic pigments.

The at least one organofunctional silane component having organic functionalities which have not been polymerised is preferably formed from an organofunctional silane with the formula:

R¹ₙR²ₘSiX₍₄₋ₙ₋ₘ₎ (I)

wherein X is a group capable for hydrolysis and for forming a chemical bond to the inorganic component after hydrolysis and R¹ and R² are independently a non-reactive organic group with the proviso, that n and m are integers, wherein n+m=1-2 and n=1-2 and m=0-1.

lo As will be discussed in more detail below, the organofunctional silane component is preferably covalently bound to the inorganic component.

In a preferred embodiment R¹ or independently R² is selected from the group consisting of (C₁-C₄₀)-alkyl-, (C₁-C₄₀)-fluorinated alkyl-, (C₁-C₄₀)— partly fluorinated alkyl-: (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₆-C₄₀)-alkenylaryl-, (C₅-C₄₀)-cycloalkyl-, (C₆-C₄₀)-alkylcycloalkyl- or (C₆-C₄₀)-cycloalkylalkylsilane.

More preferably, R¹ or independently R² is selected from the group consisting of (C₁-C₄₀)alkyl-, (C₁-C₄₀)-fluorinated alkyl-, (C₁-C₄₀)-partly fluorinated alkyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl, (C₅-C₄₀)-cycloalkyl-, (C₆-C₄₀)-alkylcycloalkyl- or (C₆-C₄₀)-cycloalkylalkylsilane.

Most preferably. R¹ or independently R² is selected from the group consisting of (C₁-C₁₀)-alkyl-, (C₆-C₁₂)-aryl-, (C₇-C₁₂)-alkylaryl-, (C₇-C₁₂)-arylalkyl-, (C₅-C₁₀)-cycloalkyl-, (C₆-C₁₁)-alkylcycloalkyl- or (C₆-C₁₁)-cycloalkylalkylsilane.

For example, R¹ or independently R² may be selected from the group consisting of (C₄-C₁₀)-alkyl-, (C₆-C₁₂)-aryl-, (C₇-C₄₀)-alkylaryl-, (C₇-C₄₀)-arylalkyl-, fluorinated (C₇-C₁₆)-alkylaryl-, (C₅-C₄₀)-cycloalkyl-, (C₆-C₁₆)-alkylcycloalkyl- or (C₆-C₁₆)-cycloalkylalkylsilane.

In certain embodiments R¹ or independently R² is selected from the group consisting of methyl, ethyl, propyl, n-butyl, iso-butyl or phenyl.

The inorganic component is generally a metal oxide, although other alternatives may be suitably employed. Preferably, the metal oxide is an oxide of a metal selected from the group consisting of silicon, aluminium, titanium, zirconium, iron, cerium, chrome, manganese, zinc, tin, antimony, boron, magnesium or mixtures thereof.

In one particularly preferred embodiment, the metallic substrate consists of aluminium or alloys thereof and the inorganic component is silica.

In certain embodiments, the hybrid inorganic/organic layer further comprises an aminosilane. For example, the hybrid inorganic/organic layer may additionally comprise a hydrolysed aminosilane, such as 3-aminopropyltriethoxysilane.

The aminosilane is preferably used as a catalyst for catalysing the sol-gel reaction leading to the formation of the inorganic network, preferably a metal oxide network.

If the inorganic network is a metal oxide the aminosilane is itself hydrolysed and at least part of it is covalently bound to the inorganic network which can be, for example, schematically depicted by the following reaction schema:

M-OH+NH₂—R—Si(OH)₃→M-O—Si(OH)₂—R—NH₂+H₂O (II)

R represents an appropriate organic residue and M-OH represents a metal atom embedded in a metal oxide network, but still having at least one hydroxy function. The aminosilane is thus at least partly incorporated into the hybrid layer.

The aminosilane is thought to catalyse the condensation step of the sol-gel reaction leading to the formation of the inorganic network.

Examples for commercially available aminosilanes are: 3-aminopropyltrimethoxysilane (Dynasylan AMMO; Silquest A-1110), 3-aminopropyltriethoxysilane (Dynasylan AMEO) or N-(2-aminoethyl)-3-aminopropyltrimethoxysilane (Dynasylan DAMO, Silquest A-1120) or N-(2-aminoethyl)-3-aminopropyltriethoxysilane, triamino-functional trimethoxysilane (Silquest A-1130), bis(gamma-trimethoxysilylpropyl)amine (Silquest A-1170), N-ethyl-gamma-aminoisobutyltrimethoxysilane (Silquest A-Link 15), N-phenyl-gamma-diaminopropyltrimethoxysilane (Silquest Y-9669), 4-amino-3,3-dimethylbutyltrimethoxy-silane (Silquest Y-11637), (N-cyclohexylaminomethyl)-triethoxysilane (Genosil XL 926), (N-phenylaminomethyl)-trimethoxysilane (Genosil XL 973), and mixtures thereof.

Most preferred examples are 3-aminopropyltrimethoxysilane (Dynasylan AMMO; Silquest A-1110), 3-aminopropyltriethoxysilane (Dynasylan AMEO) or mixtures thereof. 3-Aminopropyltriethoxysilane is the most preferred aminosilane.

It will be appreciated that there are difficulties involved in determining the amount of aminosilane incorporated into the hybrid layer. Without wanting to be bound to the level of incorporation, it is thought that the amount of aminosilane incorporated into the hybrid layer will be in the vicinity of from 1-40 mol % and more preferably from 10 to 35 mol %, referring to the total amount of metal from the metal oxide and silicon from the organofunctional silane and aminosilane.

The metallic substrate may take any suitable form. For example, this may be in the form of a particulate substance. In one embodiment, the metallic substrate is a platelet-like metallic substrate. For example, the platelet-like metallic substrate may be selected from the group consisting of aluminium, copper, gold bronze, zinc, iron and alloys therefrom or a mixture thereof. A preferred embodiment is aluminium or alloys from aluminium.

When the metallic substrate comprises a platelet-like metallic substrate, the particles preferably have an aspect ratio in a range from 5 to 400. The aspect ratio is commonly defined as the ratio of the d₅₀-value of the volume averaged particle size distribution and the mean thickness h₅₀. The meaning and determination of the h₅₀-value can be depicted from WO 2004/087816 A2.

The thickness of the hybrid inorganic/organic layer is not particularly limited, provided this has the desired effect of ameliorating or eliminating ingress of surrounding medium into the core metallic pigment particle. In certain embodiments the hybrid layer has a thickness of up to 500 nm, preferably from 10-100 nm, more preferably from 12-75 nm, for example about 14-25 nm.

When the inorganic component is a metal oxide, the ratio of organofunctional silane component having organic functionalities which have not been polymerised to metal oxide of the hybrid layer is generally in a range of 1:1 to 10:1, more preferably in a range of 2:1 to 5:1, based on molar ratios of Si from the organofunctional silane to metal M of metal oxide. In a preferred embodiment, the metal oxide of the inorganic network is silica and thus the above mentioned ratios are based on molar ratios of Si of the organofunctional silane and silica.

The ratio of metallic substrate to the hybrid layer will be dependent on a number of factors, including for example the size of the metallic substrate and the thickness of the hybrid layer. In certain embodiments, the mass ratio of core metallic pigment particle to hybrid layer is from 1:1 to 20:1 and more preferably from 1.5:1 to 5:1.

The metallic pigment coated with the hybrid inorganic/organic layer may take any suitable form, for example dependent on the particular application of the metallic pigment. In certain embodiments, the metallic pigment is in the form of a metallic powder or a paste further comprising a dispersant.

The present invention further relates to a method of coating a metallic substrate comprising:
combining the metallic substrate with a surfactant and an organofunctional silane and an inorganic component precursor to form a hydrophobic phase;
combining the hydrophobic phase with a hydrophilic liquid to form an emulsion comprising a hydrophobic phase containing the metallic substrate, the organofunctional silane and the inorganic component precursor dispersed in a continuous hydrophilic phase;
adding a catalyst to the emulsion; and
forming a hybrid organic/inorganic layer from the organofunctional silane and the inorganic component precursor on the metallic substrate to produce a coated metallic substrate.

As with the previous aspect of the invention, the organofunctional silane preferably has the formula:

R¹ₙR²ₘSiX₍₄₋ₙ₋ₘ₎ (I)

wherein X is a group capable for hydrolysis and for forming a chemical bond to the inorganic component after hydrolysis and R¹ and R² are independently a non-reactive organic group with the proviso, that n and m are integers, wherein n+m=1-2 and n=1-2 and m=0-1.

Again, R¹ or independently R² is preferably selected from the group consisting of (C₁-C₄₀)-alkyl-, (C₁-C₄₀)-fluorinated alkyl-, (C₁-C₄₀)-partly fluorinated alkyl-; (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₈-C₄₀)-alkenylaryl-, (C₅-C₄₀)-cycloalkyl-, (C₆-C₄₀)-alkyloyoloalkyl- or (C₆-C₄₀)-cycloalkylalkylsilane.

More preferably, R¹ or independently R² is selected from the group consisting of (C₁-C₄₀)-alkyl-, (C₁-C₄₀)-fluorinated alkyl-, (C₁-C₄₀)-partly fluorinated alkyl-, (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₅-C₄₀)-cycloalkyl-, (C₆-C₄₀)-alkylcycloalkyl- or (C₆-C₄₀)-cycloalkylalkylsilane.

More preferably, R¹ or independently R² is selected from the group consisting of (C₄-C₁₀)-alkyl-, (C₆-C₁₂)-aryl-, (C₇-C₄₀)-alkylaryl-, (C₇-C₄₀)-arylalkyl-, fluorinated (C₇-C₁₆)-alkylaryl-, (C₅-C₄₀)-cycloalkyl-, (C₆-C₁₆)-alkylcycloalkyl- or (C₆-C₁₆)-cycloalkylalkylsilane.

Most preferably, R¹ or independently R² is selected from the group consisting of (C₁-C₁₀)-alkyl-, (C₆-C₁₂)-aryl-, (C₇-C₁₂)-alkylaryl-, (C₇-C₁₂)-arylalkyl-, (C₅-C₁₀)-cycloalkyl-, (C₆-C₁₁)-alkylcycloalkyl- or (C₆-C₁₁)-cycloalkylalkylsilane.

In certain embodiments R¹ or independently R² is selected from the group consisting of methyl, ethyl, propyl, n-butyl, iso-butyl or phenyl.

Once again, the metallic substrate is a platelet-like metallic substrate. For example, the platelet-like metallic substrate may be selected from the group consisting of aluminium, copper, gold bronze, zinc, iron and alloys therefrom or a mixture thereof.

Likewise, the inorganic component precursor is preferably a metal oxide precursor. For example, the metal oxide precursor may be a precursor of an oxide of a metal selected from the group consisting of silicon, aluminium, titanium, zirconium, iron, cerium, chrome, manganese, zinc, tin, antimony, boron, magnesium and a mixture thereof. Preferably, the metal oxide precursor is a tetraalkoxysilane, more preferably tetraethylalkoxysilane.

The selection of the surfactant is not particularly limited. The surfactant may be cationic, anionic, non-ionic or zwitterionic. It may be for example an alkylphenol ethoxylate, an alkyl (straight or branched chain) alcohol ethoxylate, an ethylene oxide-propylene oxide copolymer or some other type of surfactant. Suitable alkylphenolethoxylates may have alkyl groups between 6 and 10 carbon atoms long, for example 6, 7, 8, 9 or 10 carbon atoms long, and may have an average number of ethoxylate groups between about 7 and 15, or between about 8 and 10, or for example about 7, 8, 9, 10, 11 or 12. The surfactant may, when dispersed or dissolved in water have a pH of between about 3.5 and 7, or between about 4 and 6, 4 and 5, 5 and 6 or 6 and 7. Suitable surfactants include PEG-9 nonyl phenyl ether (e.g. NP-9), PEG-9 octyl phenyl ether (e.g. Triton X-100) or PEG-8 octylphenyl ether (e.g. Triton X-1 14). An example for an anionic surfactant is SDS.

In certain embodiments, the surfactant is a water soluble, non-ionic surfactant with HLB (hydrophilic/lipophilic, balance) between 8 and 20, or between about 10 and 15, 10 and 14, for example a nonylphenylethoxylate. It is also envisaged that in certain embodiments it may be appropriate to employ ionic surfactants and this alternative is included within the ambit of the invention.

The hydrophilic liquid that forms the hydrophilic phase in the emulsion is preferably water and/or alcohol. For example, this may include a water/ethanol solution. The hydrophilic liquid is more preferably a mixture of water and alcohol, wherein the ratio of water to alcohol is in a range of 20:1 to 2:1 by weight.

The weight ratio of the metallic substrate to the hydrophilic liquid is preferably from 1:2 to 1:60, more preferably from 1:2 to 1:10 and most preferably from 1:3 to 1:5. If this ratio is below 1:2 stable emulsions may not form. If the ratio exceeds 1:60 the process may lose its economical benefits as the yield of coated metal pigments per batch becomes low.

It has been very surprisingly found that the addition of the surfactant led to the formation of a hydrophobic phase containing the metallic substrate, the organofunctional silane and the inorganic component precursor dispersed as an oil-in-water emulsion in the hydrophilic liquid. The size of this hydrophobic phase is mainly determined by the size of the metallic substrate which is additionally surrounded by the organofunctional silane and the inorganic component precursor. Additionally, the hydrophobic phase may contain some amount of hydrophobic solvent such as white spirit and/or solvent naphtha. These solvents stem from the metallic substrate, when this substrate was employed as a paste.

The amount of this hydrophobic solvent is typically in a range of 30-40% based on the weight of the pigment.

The weight ratio of the surfactant to the sum of (metallic substrate+inorganic component precursor+organofunctional silane) is preferably within the range of 1:0.2 to 1:3. If the amount of the surfactant is too low, it may be difficult to form a stable emulsion and the resulting pigments may have less desirable properties. If the amount is too high, secondary undesirable precipitation of hybrid inorganic/organic material not coating the metallic substrates may be observed. It is considered that micelles not containing metallic substrates are formed in the emulsion leading to these secondary precipitations.

Generally, the amount of the surfactant is predicated by the specific area of the metal substrates. For example, thin and fine metal substrates have a larger specific surface. The amount of surfactant may be adapted to the metal substrate and the amounts of inorganic precursor material and of organofunctional silane. Generally, the amount will be maintained as low as possible as residues of the surfactant will be found in the final product. The residual surfactant may be beneficial to the coated metal pigment. However, too large amounts should be avoided. The amount of residual surfactant in the coated product may be reduced by washing procedures after the coating step and after the recovering step of the metallic pigments.

The addition of the catalyst advantageously results in the rapid condensation of the hybrid layer onto the metallic pigment particles from the organofunctional silane and the inorganic component precursor in the hydrophobic phase. In a preferred embodiment, the catalyst is a hydrolysed aminosilane, such as 3-aminopropyltriethoxysilane. The mol % ratio Si for the aminosilane, referring to the total sum of moles Si of organosilane/inorganic precursor/aminosilane, is generally within the range of from 10-50%, preferably about 30-40%. If the inorganic precursor is a metal oxide other than silica, the number of mole of the metal in the metal oxide replace the number of mole of Si in this relationship.

Combining of the hydrophobic phase and the hydrophilic liquid may be achieved by any suitable means. For example, combining the hydrophobic phase and the hydrophilic liquid may comprise one or more of mixing, agitating, stirring and shaking the combined hydrophobic phase and the hydrophilic liquid.

In certain embodiments, although the invention is not so limited, after addition of the catalyst the resulting mixture is left for a period of time, for example from 2 to 4 hours, with one or more of mixing, agitating, stirring and shaking to facilitate formation of the coating on the metallic pigment particles.

The method for recovering the coated metallic pigment particles is not particularly limited. However, in a preferred embodiment recovering the coated metallic pigment particles comprises centrifugation or filtering with washing of the coated metallic pigment particles and optionally re-centrifugation or optionally re-filtering of the washed coated metallic pigment particles.

The weight ratio of the organofunctional silane and the inorganic component precursor is preferably in a range of 10:1 to 1.5:1, more preferably from 5:1 to 2:1. In a preferred embodiment, the weight ratio of the organofunctional silane and the inorganic component precursor is from 3:1 to 2:1.

The method of the invention advantageously facilitates deposition of a layer, which may be termed a “hybrid” layer. That is, a hybrid inorganic/organic layer that encapsulates a core metallic substrate. In preferred embodiments of the invention, the hybrid layer is formed from a metal oxide and an organofunctional silane precursor, for example an alkoxysilane or organoalkoxysilane, such as tetraorthoethylsilicate, or an alkyltrialkoxysilane such as methyltriethoxysilane or phenyltrimethoxysilane, or vinyltrimethoxysilane or a combination thereof. It is envisaged that the inorganic component precursor may also include a titanium alkoxide (e.g. titanium tetraethoxide, titanium isopropoxide, titanium sec butoxide titanium tert-butoxide), a zirconium alkoxide (e.g. zirconium propoxide, zirconium butoxide), or an aluminium alkoxide (e.g. aluminium sec butoxide).

The temperature of the reaction is preferably between 25° C. and 80° C., more preferably between 30° C. and 60° C. and most preferable between 35° C. and 50° C. Usually a reaction temperature of about 40° C. is sufficient. As such, the process advantageously provides for relatively low energy consumption.

The present invention consists of features and a combination of parts hereinafter fully described and illustrated in the accompanying drawings and examples, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings and exemplified in the examples. It should be appreciated that the drawings depict only typical embodiments of the invention and are therefore not to be considered limiting on its scope. The invention will be described and explained with additional specificity and detail through the accompanying drawings in which:

FIG. 1 illustrates a flow diagram of a method of an embodiment of the invention.

FIG. 2 illustrates a TEM image of coated aluminium particle. Scale bar=200 nm.

FIG. 3 illustrates a FTIR spectra (650-1600 cm⁻¹) of uncoated Al ( - . - . - . - ), coated Al (—), and equivalent phenylsiloxane particles ( - - - ).

### DETAILED DESCRIPTION OF THE PREFERRED EMBODIMENTS

As mentioned above, the present invention relates to a metallic pigments, such as so-called metallic effect pigments, and methods of coating metallic substrates. In particular, the invention relates to metallic pigments, such as those comprising lamellar metal pigment particles as the metallic substrate, where a hybrid material layer is coated onto the metallic substrate. The hybrid material layer advantageously reduces or eliminates exposure of the metallic substrate to the external environment.

Hereinafter, the present invention will be described and exemplified in more detail according to the preferred embodiments. It is to be understood that the following discussion of the invention is provided without intending any limitation thereon and without departing from the spirit of the invention as defined in the appended claims.

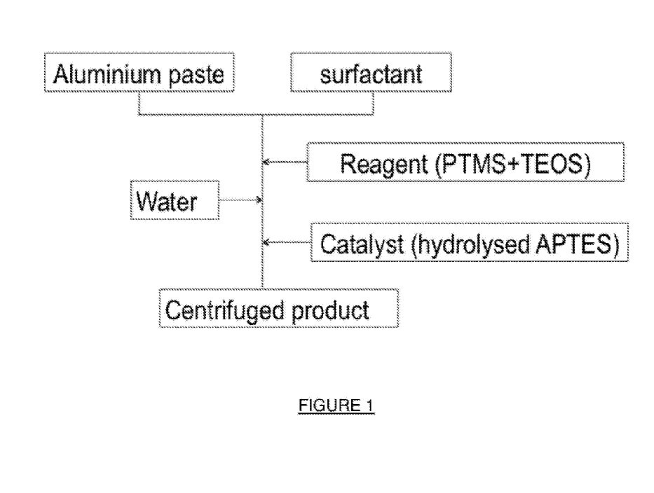

A summary of the general coating method is shown in FIG. 1. Referring to FIG. 1, a paste comprising lamellar aluminium pigment is combined with a surfactant, such as nonylphenylethoxylate, and stirred until homogeneous. A reagent that contains precursors to the coating is added, in this case a reagent containing PTMS (phenyltrimethoxysilane) and TEOS (tetraethylorthosilicate). Again, the mixture is stirred until homogeneous. This constitutes the hydrophobic phase of the subsequent emulsion, discussed below.

A hydrophilic liquid, in this case water, is added to the hydrophobic phase and the resulting mixture stirred to form an oil-in-water emulsion. That is, an emulsion in which the hydrophobic phase is a dispersed phase in a continuous hydrophilic phase. A catalyst is added to the emulsion, in this case hydrolysed APTES (3-aminopropyltriethoxysilane) and the resulting mixture stirred for several hours.

The resulting coated metallic pigment particles are then recovered by centrifugation with washing of the recovered particles, optionally with re-centrifugation of the washed particles.

### EXAMPLES

### Example 1

The synthesis below produces a coating on Al with silica/organosilica content ˜31.5 wt % of total solid (i.e. Al+silica/organosilica). In all cases milliQ H₂O refers to water with resistivity=18.2 MΩ·cm.

65 g Al paste (MEX 3580, commercially available from Eckart GmbH, Germany), equivalent to 39 g Al, was weighed into a 2 L beaker. The Al was contained in a paste in mineral spirit/solvent naphtha with non-volatile content ˜60 wt %. 60.4 g Tergitol NP9 surfactant (nonylphenylethoxylate) was mixed into the Al paste using an overhead stirrer at low speed (˜100 rpm) until homogeneous. 16.25 mL phenyltrimethoxysilane (PTMS) and 8.4 mL tetraethoxyorthosilicate (TEOS), equivalent to 70 mol % PTMS and 30 mol % TEOS on a Si basis, were added to the Al mixture, and the mixture stirred until homogeneous (˜15 minutes). 1.625 L milliQ H₂O was added to the Al mixture, and the stirring speed increased to ˜200 rpm and the mixture stirred until homogenous (˜15 minutes). 35 mL of 3-aminopropyltriethoxysilane solution in water (1:1 v/v solution) was added to the Al mixture, and the mixture left to stir for two hours.

The sample was centrifuged quickly (RCF=3000×g/3 minutes) to isolate the solid, which was then washed several times with water, re-centrifuging each time to remove the waste supernatant. The solid was then similarly washed with isopropanol, to remove the water.

The final mass of alcoholic wet paste was 158 g, with solid content 36.5 wt %, corresponding to 25% Al and 11.5% silica/organosilica

Characterisation of Coating

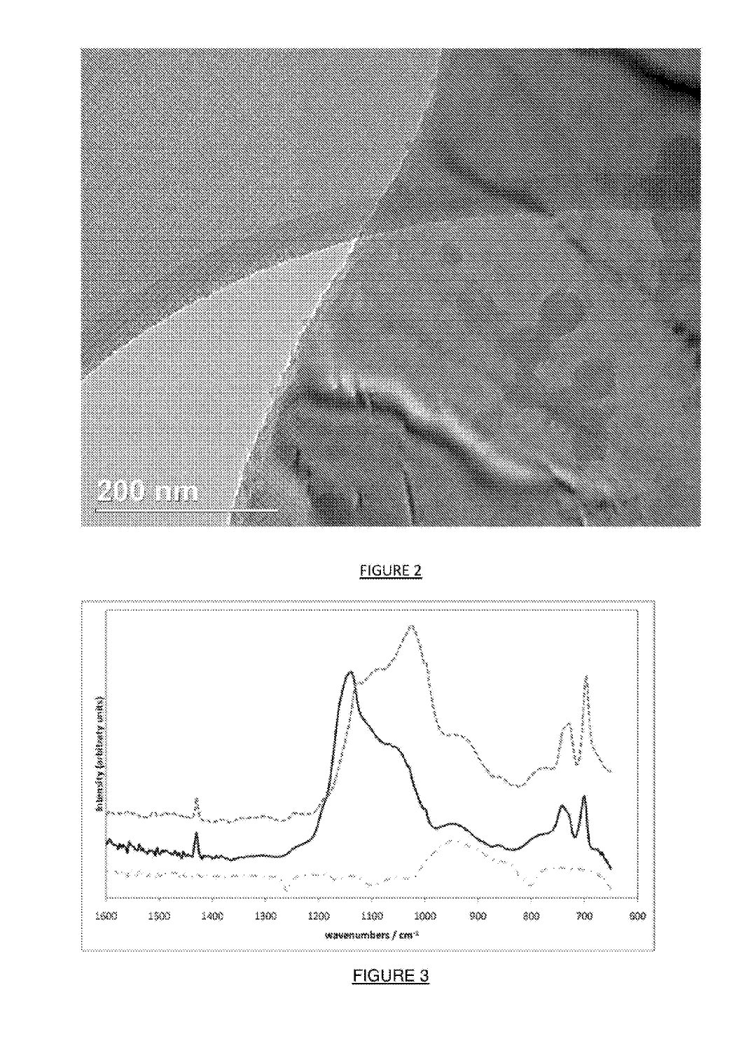

A transmission electron micrograph (TEM) of the coated sample is shown in FIG. 2. The coating is observed as a rough layer ˜15 nm thick, on the edge of the aluminium platelet.

FTIR spectra of dried, coated aluminium particles contain bands typical of phenylsiloxane. FIG. 3 contains FTIR spectra of uncoated Al ( - . - . - . - ), coated Al (—), and equivalent phenylsiloxane particles ( - - - ) made using similar chemistry. Only weak features are observed in the spectrum of the uncoated Al platelets. The most intense band in both phenylsiloxane and silica FTIR spectra is the broad antisymmetric stretching mode of the Si—O—Si network, which has a peak 1026 cm⁻¹ in the particle spectrum shown here. In the coated aluminium spectrum, the similarly broad band has a peak shifted significantly to higher energy, at 1141 cm⁻¹. This is likely due to the more distorted nature of a thin layer on a surface compared with the bulk material. In addition the thin layer can give rise to orientation effects. The distinct bands of phenylsiloxane are evident in both spectra, these being the sharp peak at 1430 cm⁻¹ and the characteristic absorption in the 760-690 cm⁻¹ range (‘Infrared analysis of organosilicon compounds: spectra-structure correlations’, Philip J. Launer, Silicon compounds: silanes and silicones, Eds. Barry Arkles and Gerald Larson, 2004, Gelest, Inc, Morrisville, Pa.).

### Example 2

The synthesis below produces a coating on Al with silica/organosilica content ˜31 wt % of total solid (i.e. Al+silica/organosilica). MilliQ H₂O refers to water with resistivity=18.2 MΩ·cm.

65 g Al paste (MEX 3580, commercially available from Eckart GmbH, Germany), equivalent to 39 g Al, was weighed into a 2 L beaker. The Al was contained in a paste in mineral spirit/solvent naphtha with non-volatile content ˜60 wt %. 124.6 g polyoxyethylene 10 tridecyl ether surfactant was mixed into the Al paste using an overhead stirrer at low speed (˜150 rpm) until homogeneous. 16.25 mL phenyltrimethoxysilane (PTMS) and 8.4 mL tetraethoxyorthosilicate (TEOS), equivalent to 70 mol % PTMS and 30 mol % TEOS on a Si basis, were added to the Al mixture, and the mixture stirred until homogeneous (˜15 minutes). The mixture was then transferred to a jacketed 2 L reactor with a total of 1.625 L of 20% ethanol (aq.) added to the Al mixture. The mixture was stirred at 275 rpm till homogeneous (˜15 minutes). The temperature was then increased to 40° C., at which point 35 mL of 3-aminopropyltriethoxysilane solution in water (1:1 v/v solution) was added to the Al mixture, and the mixture left to stir for two hours. The mixture was then allowed to cool to ambient with stirring for another two hours.

The sample was centrifuged quickly (RCF=3000×g/3 minutes) to isolate the solid, which was then washed several times with milliQ water, re-centrifuging each time to remove the waste supernatant. The solid was then similarly washed with isopropanol, to remove the water.

The final mass of alcoholic wet paste was 141 g, with solid content 40 wt %, corresponding to 28% Al and 12% silicalorganosilica.

### Comparative Example 1

Stapa II Hydrolan 3580 (commercially available from Eckart GmbH, Germany) corresponding to a silica coated aluminium effect pigment.

### Comparative Example 2

The metal pigment of this comparative example was coated according to the US 200810249209 A1.

150 of commercially available Al paste MEX 3580 (Eckart GmbH) was dispersed in 310 ml of isopropanol and the dispersion heated to boiling point. Then, 5.09 g of tetraethoxysilane were added and, a short time later, 9 g of H₂O. Subsequently a 25% strength aqueous NH₄OH solution was introduced via an automatic metering unit over a period of 3 h at a rate such that, during this time, a pH of 8.7 was attained and maintained. 1 h after the beginning of this metered addition, a solution of 0.95 g of Dynasylan MEMO and 4.8 g of trimethylolpropane trimethacrylate (TMPTMA) in 50 ml of ethanol was added. 5 min later the polymerization was initiated by adding 0.3 g of 2,2′-azobis(isobutyronitrile) (AIBN). The reaction mixture was then left with stirring at 87° C. for 4 h. Subsequently a mixture of 0 0.5 g of Dynasylan AMMO was added. The reaction mixture was stirred overnight and filtered the next day. The filtercake was dried in a vacuum drying cabinet at 100° C. for 6 h.

Gassing Stability Study:

Gassing Test 1:

All of the coated metallic effect pigments were subjected to a first gassing test. For the gassing test, 8.6 g of coated Al pigment in the form of a paste were incorporated into 315 g of colorless waterborne mixing varnish (ZW42-1100, BASF Würzburg) and brought to a pH of 8.2 using dimethanolethanolamine. 300 g of this paint were introduced into a gas wash bottle, which was closed with a double-chamber gas bubble counter. The volume of gas produced was read off, on the basis of the water volume displaced, in the lower chamber of the as bubble counter. The gas wash bottle was conditioned at 40° C. in a water bath and the test was carried out over a maximum of 30 days. The test is passed if no more than 10.5 ml of hydrogen has been evolved after 30 days.

The test could be done for the coated metal pigments as received or after subjecting the metal pigments to strong mechanical stress prior to the gassing test. Here, the metal pigment paste was subjected in a kitchen aid (Professional) for ten minutes at stage 1. As a shearing tool a kneading hook was used.

Gassing Test 2:

Gassing test 2 is a strongly enhanced test reflecting the increasing demand of the coatings industry for more stable metal pigments.

Here the coated metal pigments were pasted with isopropanol to a paste containing 55 wt.-% solids. 15 g of this paste were suspended in 10 g butylglycol under stirring for some minutes. 15 g of a colourless binder and 0.8 g of a dimethylethanolamine (10%) were added and stirred for some minutes.

22 g of this suspension were added to a mixture of 200 g of a lacquer used for testing effect pigments and 75 g of a water based paste containing Fe₂O₃ pigments and additionally 6 g of a water based paste containing black iron oxide pigments. The suspension was brought to a pH of 9.0 with dimethylethanolamine.

Iron oxide pigments are known to enhance gassing of aluminium effect pigments in such tests. In this test an unusually high amount of iron oxide pigments were used which was in a ratio of 2:1 compared with known iron oxide gassing tests.

265 g of this suspension were filled in a gas wash bottle, which was closed with a double-chamber gas bubble counter. The gassing conditions were the same as in test 1. The test was passed if after 28 days not more than 10 ml hydrogen had been evolved. In this case the test was sometimes conducted to even 40 days.

TABLE 1
Results gassing tests

| | |
|---|---|
| Gassing test 1 | Gassing test 2 |

| | 30 d | 30 d | 28 d |
|---|---|---|---|
| | without | with | without |
| Sample: | shearing | shearing | shearing |
| Example 1: | Passed | Passed | Passed |
| | | | (28 d) |
| Example 2: | Passed | Passed | Passed |
| | | | (40 d) |
| Comp. Example 1: | Passed | Not | Not passed |
| | | passed | |
| Comp. Example 2: | Passed | Passed | Not passed |

Neither the standard gassing test 1 with kneading, nor the enhanced gassing test 2 was passed by Comparative Example 1. All gassing tests were passed by the two inventive examples 1 and 2. The pigments of example 2 even passed the harsh gassing test 2 for 40 days. Similar results have been obtained by further inventive examples when replacing phenyltrimethoxysilane by equivalent amounts of hexyltrimethoxysilane or butyltrimethoxysilane.

The pigments of comparative example 1 did not pass the gassing test 1 with shearing conditions. It seems that the silica coating used here as the passivating layer does not have enough flexibility to withstand the shearing forces employed in the shearing test. The pigments of comparative example 2 passed gassing test 1 under mild conditions and under shearing conditions as the hybrid layer of this comparative example exhibits a certain degree of flexibility. However, these pigments did not pass the harsh conditions of gassing test 2.

Optical Properties:

Prior to spay-coating the content of active aluminum of each pigment sample was determined. Here the pigments were suspended in concentrated hydrochloric acid. Under these conditions each of the aluminium substrates was completely dissolved releasing hydrogen gas. The volume of the hydrogen gas evolved was measured and the amount of active aluminium calculated. The amounts of coated aluminium effect pigments in all spray-coatings were calculated to be based on the same content of active aluminium pigment, respectively.

All coated aluminum pigments were pasted with isopropanol to a non-volatile content of 55 wt. %. 15 g of these aluminium pigment pastes and 12 g butylglycol were weighed into a 175 ml beaker and predispersed using a brush. The suspension was then stirred for 10 min at 2,000 rotations/min using a 35 mm ring gear. The pH was adjusted to 8.1-8.3 using dimethylethanolarnine.

A certain amount of this suspension was weighed into 150 g of a commercially available water-based coating for automotives (BASF) such that the final amount of active aluminum in the water-based coating was 3.0 wt. %. The lacquer was sprayed in two turns on aluminium panels at a final thickness of the base coat of 14-18 μm. The coating was dried at 80° C. for 10 min. A clear coat (BASF) was applied at a thickness of 35-40 μm.

The optical properties (Brightness-values L* in the 12a*b*-system) were measured with an instrument of x-Rite at an angle of incidence of 45° and five angles in cis geometry (15°; 25°; 45°; 75° und 110°).

The Flop index can be calculated according to DuPont by the following formula: (A. B. J. Rodriguez, JOCCA, (1992(4)) p. 150-153):

$$Flopindex = 2 , 69 \times \frac{{( {L}_{{15}^{*}}^{*} - {L}_{{110}^{*}}^{*} )}^{1.11}}{{( {L}_{{45}^{*}}^{*} )}^{0.86}}$$

TABLE 2
Optical properties of samples

| | L* | | | | | Flop index |
|---|---|---|---|---|---|---|
| Sample | 15° | 25° | 45° | 75° | 110° | (DuPont) |
| Example 1: | 137 | 109.4 | 63.1 | 33.1 | 30.1 | 13.7 |
| Example 2 | 136.3 | 109.4 | 63.6 | 36.6 | 29.3 | 13.5 |
| Comp. | 135.6 | 110.2 | 65.7 | 38.1 | 31.0 | 12.8 |
| Example 1 | | | | | | |
| Comp. | 132.1 | 111 | 66.5 | 39 | 33.7 | 11.9 |
| Example 2: | | | | | | |

The inventive examples exhibited the best optical properties regarding flop and brightness in the 15° angle. The comparative example 2 had the worst optical properties. Even though this sample showed an improvement in the gassing stability compared to comparative example 1 it's optical properties seem to be worse.

### CONCLUSION

A method has been developed that produces a protective coating on a metallic substrate using a water soluble surfactant to emulsify the particles in a water-based emulsion, and addition of sol-gel reagents to form a hybrid layer, for example a hybrid silica/organosilica layer, which adheres to the particle surface. Experiments have shown that this layer can act to reduce interaction with the surrounding medium by reducing degradation of the core material by preventing or slowing ingress of destabilizing elements in the surrounding medium. Moreover, the hybrid nature of the coating provides additional ductility and adhesion to the metallic substrate, thus enhancing the protective capability of the coating.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A metallic pigment comprising a metallic substrate coated with a hybrid inorganic/organic layer, wherein said hybrid inorganic/organic layer comprises a network of an inorganic component and at least one organofunctional silane component having organic functionalities which have not been polymerised.

2. The metallic pigment according to claim 1, wherein said at least one organofunctional silane component having organic functionalities which have not been polymerised has been formed from an organofunctional silane with the formula:
R¹ₙR²ₘSiX₍₄₋ₙ₋ₘ₎ (I)
wherein X is a group capable for hydrolysis and for forming a chemical bond to the inorganic component after hydrolysis and R¹ and R² are independently a non-reactive organic group with the proviso, that n and m are integers, wherein n+m=1-2 and n=1-2 and m=0-1.

3. The metallic according to claim 1, wherein the organofunctional silane component is covalently bound to the inorganic component.

4. The metallic according to claim 2, wherein R¹ or independently R² is selected from the group consisting of (C₁-C₄₀)-alkyl-, (C₁-C₄₀)-fluorinated alkyl-, (C₁-C₄₀)-partly fluorinated alkyl-; (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₈-C₄₀)-alkenylaryl-, (C₅-C₄₀)-cycloalkyl-, (C₆-C₄₀)-alkylcycloalkyl- or (C₆-C₄₀)-cycloalkylalkylsilane.

5. The metallic pigment according to claim 2, wherein R¹ or independently R² is selected from the group consisting of (C₁-C₄₀)-alkyl-, (C₁-C₄₀-fluorinated alkyl-, (C₁-C₄₀)-partly fluorinated alkyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₅-C₄₀)-cycloalkyl-, (C₆-C₄₀)-alkylcycloalkyl- or (C₆-C₄₀)-cycloalkylalkylsilane.

6. The metallic pigment according to claim 2, wherein R¹ or independently R² is selected from the group consisting of C₁-C₁₀)-alkyl-, (C₆-C₁₂)-aryl-, (C₇-C₁₂)-alkylaryl-, (C₇-C₁₂)-arylalkyl-, (C₅-C₁₀)-cycloalkyl-, (C₆-C₁₁)-alkylcycloalkyl- or (C₆-C₁₁)-cycloalkylalkylsilane.

7. The metallic pigment according to claim 2, wherein R¹ or independently R² is selected from the group consisting of methyl, ethyl, propyl, n-butyl, iso-butyl or phenyl.

8. The metallic pigment according to claim 1, wherein the hybrid inorganic/organic layer further comprises an aminosilane.

9. The metallic pigment according to claim 1, wherein the metallic substrate is a platelet-like metallic substrate.

10. The metallic pigment according to claim 9, wherein said platelet-like metallic substrate is selected from the group consisting of aluminium, copper, gold bronze, zinc, iron and alloys therefrom or a mixture thereof.

11. The metallic pigment according to claim 1, wherein the inorganic component is a metal oxide.

12. The metallic pigment according to claim 11, wherein said metal oxide is an oxide of a metal selected from the group consisting of silicon, aluminium, titanium, zirconium, iron, cerium, chrome, manganese, zinc, tin, antimony, boron, magnesium and a mixture thereof.

13. The metallic pigment according to claim 1, wherein the metallic substrate consists of aluminium or alloys thereof and the inorganic component is silica.

14. The metallic pigment according to claim 1, wherein the inorganic component is a metal oxide and the ratio of organofunctional silane component having organic functionalities which have not been polymerised to metal oxide component of the hybrid layer is in a range of 1:1 to 10:1, based on molar ratios of Si from the organofunctional silane to metal M of the metal oxide.

15. The metallic pigment according to claim 1, wherein the metallic pigment is in the form of a metallic powder or a paste further comprising a dispersant.

16. A method of coating a metallic substrate comprising:
combining said metallic substrate with a surfactant and an organofunctional silane and an inorganic component precursor to form a hydrophobic phase;
combining said hydrophobic phase with a hydrophilic liquid to form an emulsion comprising said hydrophobic phase containing said metallic substrate, said organofunctional silane and said inorganic component precursor dispersed in a continuous hydrophilic phase;
adding a catalyst to said emulsion; and
forming a hybrid organic/inorganic layer from said organofunctional silane and said inorganic component precursor on said metallic substrate to produce a coated metallic substrate.

17. The method according to claim 16, wherein said organofunctional silane has the formula:
R¹ₙR²ₘSiX₍₄₋ₙ₋ₘ₎ (I)
wherein X is a group capable for hydrolysis and for forming a chemical bond to the inorganic component after hydrolysis and R¹ and R² are independently a non-reactive organic group with the proviso, that n and m are integers, wherein n+m=1 -2 and n=1-2 and m=0-1.

18. The method according to claim 17, wherein R¹ or independently R² is selected from the group consisting of (C₁-C₄₀)-alkyl-, (C₁-C₄₀)-fluorinated alkyl-, (C₁-C₄₀)-partly fluorinated alkyl-; (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₈-C₄₀)-alkenylaryl-, (C₅-C₄₀)-cycloalkyl-, (C₆-C₄₀)-alkylcycloalkyl- or (C₆-C₄₀)-cycloalkylalkylsilane.

19. The method according to claim 17, wherein R¹ or independently R² is selected from the group consisting of (C₁-C₄₀)-alkyl-, (C₁-C₄₀)-fluorinated alkyl-, (C₁-C₄₀)-partly fluorinated alkyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₅-C₄₀)-cycloalkyl-, (C₆-C₄₀)-alkylcycloalkyl- or (C₆-C₄₀)-cycloalkylalkylsilane.

20. The method according to claim 17, wherein R¹ or independently R² is selected from the group consisting of C₁-C₁₀)-alkyl-, (C₆-C₁₂)-aryl-, (C₇-C₁₂)-alkylaryl-, (C₇-C₁₂)-arylalkyl-, (C₅-C₁₀)-cycloalkyl-, (C₆-C₁₁)-alkylcycloalkyl- or (C₆-C₁₁)-cycloalkylalkylsilane.

21. The method according to claim 17, wherein R¹ or independently R² is selected from the group consisting of methyl, ethyl, propyl, n-butyl, iso-butyl or phenyl.

22. The method according to claim 16, wherein the metallic substrate is a platelet-like metallic substrate.

23. The method according to claim 22, wherein said platelet-like metallic substrate is selected from the group consisting of aluminium, copper, gold bronze, zinc, iron and alloys therefrom or a mixture thereof.

24. The method according to claim 16, wherein said inorganic component precursor is a metal oxide precursor.

25. The method according to claim 24, wherein said metal oxide precursor is a precursor of an oxide of a metal selected from the group consisting of silicon, aluminium, titanium, zirconium, iron, cerium, chrome, manganese, zinc, tin, antimony, boron, magnesium and a mixture thereof.

26. The method according to claim 22, wherein the metal oxide precursor is a tetraalkoxysilane.

27. The method according to claim 16, wherein said surfactant is a water soluble, non-ionic surfactant with HLB ranging from 8-20.

28. The method according to claim 27, wherein said surfactant is selected from the group consisting of alkylphenol ethoxylate, an alkyl (straight or branched chain) alcohol ethoxylate, an ethylene oxide-propylene oxide copolymer.

29. The method according to claim 16, wherein said hydrophilic liquid is a mixture of water and alcohol, wherein the amount of water to the amount of alcohol is in a range of 20:1 to 2:1 by weight.

30. The method according to claim 16, where said catalyst is a hydrolysed aminosilane.

31. The method according to claim 16, wherein after addition of said catalyst the resulting mixture is left for a period of time with one or more of mixing, agitating, stirring and shaking to facilitate formation of said hybrid organic/inorganic layer on said metallic substrate.

32. The method according to claim 16, further comprising recovering said coated metallic substrate by centrifugation or filtering with washing of said coated metallic substrate and optionally re-centrifugation or re-filtering of said washed coated metallic substrate.

33. The method according to claim 16, wherein the weight ratio of the organofunctional silane and the inorganic component precursor is in a range of 10:1 to 1.5:1.
